(19) United States
(12) Patent Application Publication
(10) Pub. No.: US 2005/0075782 A1
(43) Pub. Date: Apr. 7, 2005

(54) Vehicle and traffic information processing system

(76) Inventor: John Arnold Torgunrud, Mountain View, CA (US)

Correspondence Address: JOHN TORGUNRUD, 100 N WHISMAN RD #3614, MOUNTAIN VIEW, CA, 94043, US

(21) Appl. No.: 10/367,802

(22) Filed: Feb. 19, 2003

Related U.S. Application Data
(60) Provisional application No. 60/357,882, filed on Feb. 21, 2002.

(51) Int. Cl. G06G 7/76

(52) U.S. Cl. 701/117

(57) ABSTRACT

This traffic system improves transportation for land or sea traffic grids by providing current traffic flow information to each vehicle operator. It consists of vehicle-carried units that triangulate their position from GPS signals, determine direction and speed of the vehicle, and send these and optional information to a central server. Each unit receives traffic flow and other optional information when requested and if available. The information is reported as an overlay to electronic maps, and serves as a basis of optimized route planning. The raw data is compliant with GPS grids and can be used in multiple transportation systems. The server can act as traffic control manager and archive for multiple traffic systems since it receives position, direction and speed from numerous similarly equipped vehicles and continually updates traffic information to requesting units through a wireless signal. The system enables tracking of individual vehicles.

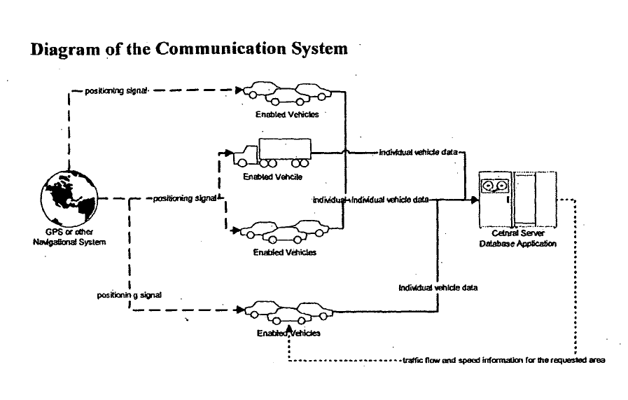

### BACKGROUND OF THE INVENTION

This invention is a transportation grid information system that gives the individual user of the grid the information on the use of the grid in the surrounding area by other users, so that users can plan their optimal routing.

Current transportation grid information systems provide feedback to individual users on surrounding traffic conditions and speeds. The feedback is limited to very subjective radio broadcasts for trouble spots, is infrequent and stale, and has limited utility for route planning. Special signage regarding specific road hazards and weather conditions is maintained by government agencies, but these are very locality specific. There are also fixed units for measuring traffic flow at specific locations, and this information is transmitted to the driver through radio, signage, or the internet; these have not proven to be a cost effective method of gathering data because of the large number of stationary units needed to provide reasonable coverage and data volume to populate a robust informational system.

In law enforcement, individuals may be restricted in operation of vehicles, but these restrictions are difficult to monitor and enforce. The system described in this patent claim would enable law enforcement authorities to place transmitting units on such restricted vehicle to monitor their use and ensure their operator's compliance with the law. For example, drivers that can only drive their vehicles to and from work could be easily monitored as to their compliance.

In the marine transportation environment, traffic information reporting is currently limited to being relayed by traffic controllers, human operators. This information is very costly and prone to errors due to individual interpretation, and other forms of human error. The information is gathered by radar observation and is transmitted by traffic control operators to the concerned users verbally by radio transmission. This information is subject to verbal misinterpretation and is only general in nature. The verbal transmission can also be degraded by radio interference. The system described in this patent claim leverages accuracy of GPS vector data to provide better information to ship operators.

There are many other transportation networks that are not quantified, but have information needs and can benefit from application of effective traffic information systems. One example would be situations where bicycles are used as the major form of transportation to and from work (seen in several large metropolitan areas in Asia).

All current patents have been granted for traffic information systems are specific to a single transportation network, such as highways only or marine waterways only. These existing patents also describe a protocol where the speed and direction of individual vehicles are determined at the central server system. In the approach described here, this will be determined at the sending unit, eliminating the need for excessive processing at the central server.

### BRIEF SUMMARY OF THE INVENTION

This disclosure describes a method of communication between various vehicles and a central database-enabled application that benefits the operator or owner of the said vehicle in any of the following ways:
As a real-time traffic information system in their traffic grid
As a navigational aid; providing best route information towards the desired destination
As a traffic congestion avoidance system
As specific vehicle tracking informational system
As a collision avoidance system
The server that receives the data from the individual transportation units provides
Real time traffic speed and direction data on any area to the individual units
Has the ability to track specific units
Has the ability to transmit data on specific units if that information is requested
Has the ability to achieve historic data for planning purposes
Has the ability to operate on any transportation system on water or land.

The vehicle may be land or water based or an air cushion vehicle.

### DETAILED DESCRIPTION OF THE INVENTION

This is a system that provides information on traffic flows to individual transportation units—such as cars, trucks, boats, ships, bicycles, motorcycles, air cushion vehicles and others —so their operators can execute an efficient route plan. This system would enable an optimal utilization of traffic grids, whether they are for roadways, waterways, bike paths, or other transportation networks.

For city driving and highway systems, individual drivers will receive dynamic data flow that overlays speed and direction of traffic onto conventional on-board road mapping systems. Using this combined information, vehicle operators can make intelligent route choices based on current data, thus avoiding traffic jams, accidents, road repair closures, and other impediments.

In some cultures, primarily in Asia, bicycles may be the chosen means of individual transportation; this may become true in inner cities of America, Europe and Africa at a future time. Optimal routing will again be decided by the traffic flow that is however not restricted to conventional roadways. If the data received is based on a GPS grid instead of a road map, operators will be able to overlay it on the mapping system of their choice that are more suited to their needs than conventional road maps.

Similar considerations apply to waterway transportation traffic systems. The system described in this patent would be an inexpensive alternative for the costly traffic control systems currently in use. The system described in this patent would be extremely useful in collision avoidance and Automatic Radar Plotting Aid (ARPA) applications. Electronic marine mapping systems now commonly in use could be easily combined with traffic information. The radar data relayed subjectively by controllers will always be less accurate than GPS grid data and vector information. Using the system described in this patent, commercial boat operators would have the exact position, course, speed and identity of the vessels in their area (information provided by the proposed system), beyond limitations of individual radar unit-range. The vast amount of inland and coastal waterways already has wireless coverage. In the marine world, expensive radar systems are in place to get traffic information to traffic controllers who relay traffic information to the individual vessel operators. This system would replace the communication requirement currently loaded on the traffic control operator.

This system described in this patent would also be cost effective because it has no fixed units. Current systems have a large number of fixed units for collecting traffic data deployed at strategic locations on the traffic grid. A much larger number of recording units would be necessary to provide enough detailed traffic data to be useful to the average vehicle operator. Many analyses indicate that it would be prohibitively costly to deploy enough stationary units to provide complete and adequate coverage. If, instead, a large number of vehicles were sending information to a central location, a far superior information gathering and analysis could be obtained for a far larger geographic area.

In the future, alternative transportation grids may be developed utilizing aircushion vehicles and other non-traditional transportation devices. However, in all cases, the principle of users sending data by a wireless signal to a central server and receiving customized traffic information that optimizes routing, applies.

The central server will be able to collect data from numerous individual users and store that data in a generalized format using a GPS positioning grid. Current data would be transmitted with any degree of granularity requested, for any given area, depending on requests of individual users. Since the database is GPS grid based, it will be interoperable with a plurality of transportation networks: highways, waterways, bicycle trails, or even the open countryside. The server will be able to store historic data; this would be very useful for future infrastructure planning and improvements on any transportation grid, whether it be new roadway construction or channel dredging.

Since the velocity and direction are calculated at the individual transportation GPS unit, server processing is minimized.

1. My invention is a device: in a moving transportation vehicle¹, this specialized device² receives a series of positioning signals from GPS-enabled satellites or other navigational systems; using these signals,
It calculates the vehicle's velocity (direction and speed).
It transmits by a wireless network the vehicle's position and velocity to a central server database application.
It may transmit the identity of the vehicle
It transmits a demand for traffic information in its area of interest
It receives back by wireless network the requested data
It reports the received information to the vehicle operator
It can display the received information to the vehicle operator on a generic grid display³
It can combine this traffic information with a resident mapping system⁴ display
It can display the identity of traffic in the area of interest
It is flexible enough to meet the needs of any transportation network, on road, off road, over waterways or at sea.
¹ Vehicles include car tucks buses bikes, boats, air-cushion devices, hovercraft or any other machine used for transportation of materials or individuals on land, over waterways, or at sea
² Device could include a customized cellular telephone, a PDA, or any other appliance capable of transmitting and receiving a wireless signal
³ Display could include liquid crystal screens, CRTs, heads-up displays or any other device capable of projecting and/or displaying visual and/or audio information
⁴ Mapping systems would be electronic, and could include road, marine, topographic, or any other map representational systems.

2. My invention is a central server database enabled application that will:
Receive data from any number of mobile units in any transportation system through wireless communication protocols
Insert this data into a GPS location data base
Process the data, which includes OPS grid position, direction, speed and (optionally) identification, response parameters, from numerous similarly equipped mobile units to derive traffic flow information
Return to individual mobile units, through a wireless transmission, this traffic flow information for the requested area and granularity of data
Archive data for historic analysis or planning
Have the ability to track individual units, provided identification is given
Have the ability to provide to requesting users identification information on surrounding vehicles, provided this information was given
Have the ability to store data on individual transportation units if identification was originally sent by the transportation unit
Have the ability to display historic data on general traffic flows or on individuals users
Provide current all previously described information on request in real-time, with a minimal processing delay
